(19) United States
(12) Patent Application Publication
(10) Pub. No.: US 2021/0061040 A1
(43) Pub. Date: Mar. 4, 2021

(54) HEIGHT ADJUSTMENT SYSTEM

(71) Applicant: AKTV8, LLC, Brighton, MI (US)

(72) Inventors: Joshua Coombs, Brighton, MI (US); Gary Meyers, Brighton, MI (US)

(21) Appl. No.: 17/008,132

(22) Filed: Aug. 31, 2020

Related U.S. Application Data
(60) Provisional application No. 62/894,542, filed on Aug. 30, 2019.

(51) Int. Cl. B60G 17/015; B60G 17/019; B60G 17/052

(52) U.S. Cl. CPC B60G 17/0155; B60G 17/019; B60G 17/0525; B60G 2400/51222; B60G 2600/04; B60G 2500/302; B60G 2400/25; B60G 2204/20; B60G 2202/152

(57) ABSTRACT

Disclosed is a low cost air suspension adjustment system that employs a visible height indicator. The combination of an externally-viewable suspension height “green zone” or desired height indicator and automatic pressure control enables a low-cost simple height adjustment system. The height adjustment system of the present invention includes a PCU which can be a module that houses an ECU (electronic control unit with a microprocessor), at least one solenoid valve 16, a pressure sensor 18 and a remote control device to instruct the ECU.

### RELATED APPLICATIONS

This application claims the benefit of U.S. Provisional Application No. 62/894,542, filed on Aug. 30, 2019, which is incorporated herein by reference in its entirety.

### STATEMENT REGARDING FEDERALLY SPONSORED RESEARCH

NONE.

### TECHNICAL FIELD

This invention relates generally to vehicle height adjustment systems and more particularly to height adjustment of vehicles using air springs.

### BACKGROUND OF THE INVENTION

Air suspension systems are widely used in various vehicle types. Vehicles with primary air suspension require automatic height control to maintain proper suspension height while driving. In the event these air suspension systems leak the vehicle's height will reduce. In some situations, the suspension can get too low and bounce off the jounce bumpers, reducing ride quality and comfort and potentially damaging the vehicle and its contents.

Commercial trucks and trailers use “height control valves” or HCVs. These are “dumb” pneumatic valves attached to the suspension that actuate to maintain height. The HCVs rely on the engine-driven air compressor and consume large amounts of air as the vehicle travels. The HCVs continuously vent and fill as the vehicle travels over bumps.

Vehicles that do not have large engine-driven compressors must rely on small 12 VDC compressors. The use of HCV valves consume so much air that the small electric compressor will exceed its duty cycle and fail quickly. Electronic height control is required for these vehicles to save the 12 VDC compressors. Electronically controlled air suspension systems use height sensors to replace the HCVs. The height sensors are attached to the vehicle frame and suspension to measure vehicle height. Algorithms in the ECUs then filter the height information and intelligently control height using solenoid valves. These systems minimize air consumption allowing a 12 VDC compressor to be used instead of a large engine-driven compressor. But these electronic systems are very expensive, requiring height sensors, solenoid valves, and pressure sensors.

Depending on the vehicle, primary suspension height adjustment systems are used on both 1-point and 2-point (left+right) truck and trailer air suspension systems. It will be appreciated by those of ordinary skill in the art that one point systems control both sides of the vehicle or trailer simultaneously, while 2-point systems control the left and right sides of the vehicle or trailer independently.

A 1-point system control has one height sensor, one pressure sensor, and one solenoid valve to exhaust. The ECU (electronic control unit) powers the compressor to increase air spring pressure which increases height. Once the target height window is achieved, the ECU commands the compressor Off. If the height is too high, the ECU commands the exhaust solenoid Open, relieving pressure until target height is achieved. These systems are expensive due to the height sensor and the more sophisticated ECU that reads and instructs based upon the height sensor.

It is not possible to use pressure sensors only to control height as the air spring pressure is dependent on vehicle loading. EG an unloaded vehicle air spring pressure may be 20 psi to achieve safe ride-height, while a loaded vehicle may require 70 psi air pressure to achieve the same height.

Height sensors are typically employed on both sides, left and right, for 2-point height control of a vehicle. 2-point systems usually use a tank to retain pressurized air. These usually require four solenoid valves. For example using a “galley” connected manifold there will be 1 solenoid valve to isolate the exhaust, 1 solenoid valve to isolate the tank and 2 solenoid valves to isolate left and right sides. If an air spring isolated manifold is used, you typically have a left inflate solenoid valve, a left deflate solenoid valve, a right inflate solenoid valve and a right deflate solenoid valve.

In these systems, multiple solenoid valves and pressure sensors drive up cost. In a galley connected manifold: one galley sensor can be used to connect to each of the solenoid valves by opening one valve at a time to measure each pressure. An air spring isolated manifold typically uses 2 sensors, one for the left and one for the right and a third for the tank. Again, the multiple sensors drive up costs.

Solenoid valves, pressure sensors, and height sensors drive the expense of these systems. Reducing the number of each is desired. There is a need for a simple, low cost control system that can maintain primary suspension height for both 1-point and 2-point (left+right) truck and trailer air suspension systems, also for vehicles with high centers of gravity.

### SUMMARY OF THE INVENTION

In general terms, the invention as disclosed provides a low cost height adjustment system by employing a visible height indicator. The combination of an externally-viewable suspension height “green zone” indicator and an automatic pressure control enables a low-cost simple height adjustment system.

The air suspension height control system of the present invention includes an electronic control unit with a microprocessor. At least one air pressure sensor is operatively connected to the electronic control unit. The air pressure sensor reads air spring pressure related to the air suspension. At least one solenoid valve is operatively connected to the electronic control unit to exhaust air from the air suspension. An air supply is coupled to the electronic control unit to supply air to the air suspension. A visible height indicator adapted to visually display the air suspension height and indicating an optimal height or range.

A controller is operated by an operator to signal the electronic control unit with instructions to supply air from the air supply to raise the air suspension or operate said solenoid valve to exhaust air to lower the air suspension to a desired height range. The electronic control unit can store the desired pressure range and maintain the air suspension within said desired height range.

In a further general embodiment, three solenoid valves can independently control the first and second sides. One of the valves performs the exhaust function to lower the sides independently and the second and third solenoid valves are independently opened to inflate the sides separately

In a still further embodiment, an electronic height sensor can be used on one side of the vehicle and visual indicator on the other side for independent adjustment of the sides. The system can also include an air tank for more rapid response and reservoir of air.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a schematic view of the height adjustment system of the present invention for 1-point control.

FIG. 2 is a side view of a vehicle air suspension with the visual height indicator and gauge.

FIG. 3 is a side representational view of the visual height indicator and gauge.

FIG. 4 is a perspective view of a first embodiment of the human machine interface device.

FIG. 5 is a perspective view of a second embodiment of the human machine interface device.

FIG. 6 is a schematic view of the height adjustment system of the present invention for 2-point control.

FIG. 7 is a schematic view of the further embodiment of the height adjustment system of the present invention for 2-point control.

FIG. 8 is a schematic view of the further embodiment of the height adjustment system of the present invention for 2-point control including a height sensor.

FIG. 9 is a schematic view of the further embodiment of the height adjustment system of the present invention for 2-point control with an air tank.

FIG. 10 is a schematic view of the further embodiment of the height adjustment system of the present invention for 2-point control with a height sensor and air tank.

### DETAILED DESCRIPTION OF A PREFERRED EMBODIMENT

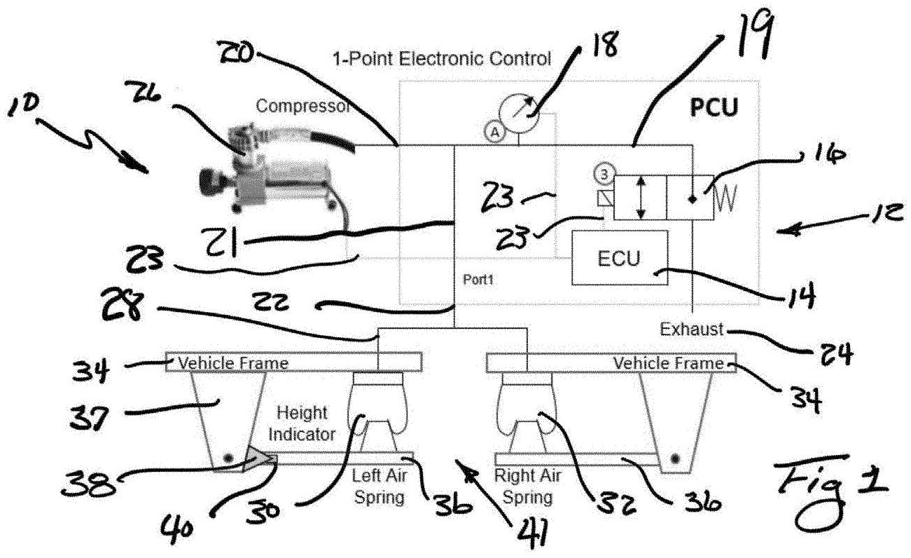

With reference to FIG. 1, a first embodiment of the height adjustment system of the present invention is generally illustrated at 10. The height adjustment system 10 is a 1-point system. It includes a PCU (Pneumatic control unit) 12. The PCU 12 is a module that houses an ECU (electronic control unit with a microprocessor) 14, a solenoid valve 16 and a pressure sensor 18. It will be understood by those of ordinary skill in the art that the PCU 12 is not required and the ECU 14, solenoid valve 16 and pressure sensor 18 could be mounted separately. Additionally, any combination of the ECU 14, solenoid valve 16 and pressure sensor 18 could be mounted within the PCU 12. The pressure sensor 18 as well as pressure sensor 76 to be discussed below are typically well known and commercially available electronic sensors. A PCU module 12 is commercially available, manufactured and sold by the assignees of this application under the brand name iAir. The iAir module is protected by U.S. Pat. Nos. 9,834,056 and 10,259,284 which are incorporated herein by reference.

The PCU 12 has an inlet 20 that is connected to an air compressor 26, an outlet 22 connected to conduits 28 that in turn connect to the left and right air springs 30 and 32. When the term conduits or lines are used, it is intended broadly to refer to internal air passages, or lines, hoses, and external air lines. The module has an internal conduit 21 for communicating air from the compressor 26 to the outlet 22. An exhaust port outlet 24 interfaces with a solenoid valve 16. The solenoid 16 is normally closed but when energized by the ECU 14 opens to exhaust air from the module 12. The pressure sensor 18 communicates with the internal air conduit 19 and with the ECU 14. Communication between the pressure sensor 18, solenoid valve 16 and the compressor are typically through a circuit board or direct wiring. The connections are shown with the dotted lines 23. In the disclosed embodiment compressor 26 is a 12 VDC compressor.

The air suspension 41 in this example has left and right air springs 30 and 32. The air springs 30 and 32 are illustrated mounted between a vehicle frame 34 and the wheel support arm 36. The term air springs or air suspension are intended to broadly cover any vehicle support system that can be raised and lowered by air pressure. such as for example air springs, air cylinders, air shocks, hybrid air and hydraulic fluid shocks, air jacks, etc. The term vehicle is intended to have the broad meaning of anything used for transmission, a carrier of any kind, such as for example, a car, truck, van, recreational vehicle (RV), semi tractor, semi trailer, and any type of trailer. The wheel support arm 36 is pivotally mounted to bracket 37. As the left and right air springs 30 and 32 are inflated by the compressor 26, the vehicle frame 34 raises, raising the vehicle. When the springs 30 and 32 are deflated, the vehicle frame 34 lowers. The springs 30 and 32 are deflated through the exhaust of air through the exhaust 24.

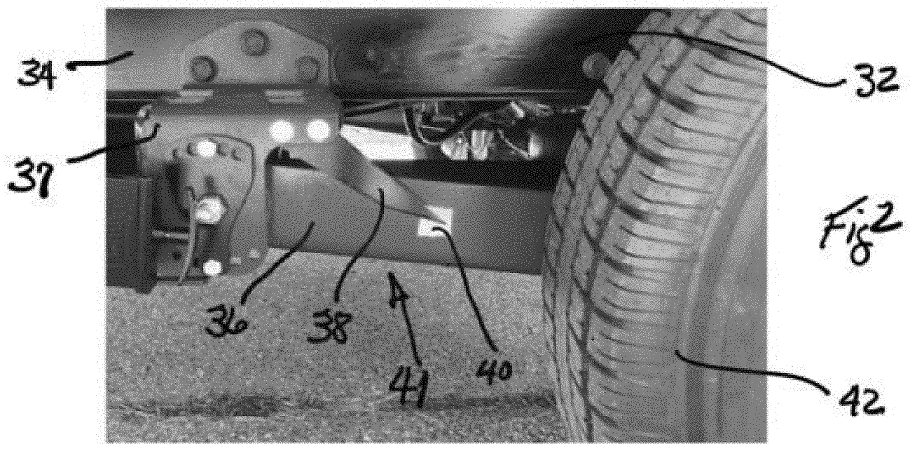

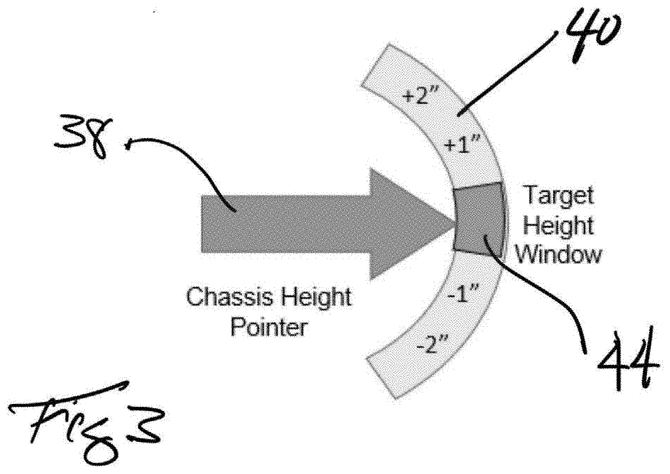

An operator visible height indicator 38 and gauge 40 are mounted to the suspension 41. The indicator 38 is mounted to the bracket 37 and the gauge 40 is mounted to the arm 36. It will be appreciated that the indicator 38 and gauge 40 could have reversed positions. The indicator 38 and gauge 40 can also be seen in FIGS. 2 and 3. As the arm 36 moves in response to inflation of deflation of springs 30 and 32, the indicator 38 moves with respect to gauge 40. Gauge 40 has a target height window 44. When the indicator 38 is in the target height window 44 of the gauge 40, the vehicle is at the correct height. In FIG. 3, the operator visible height indicator is shown with optional height in inches.

In operation, the operator adjusts (inflates or deflates) the air spring 30 and 32 pressure using an HMI (human machine interface) while watching the visible suspension height indicator 38 and gauge 40. The HMI is operatively connected to the ECU 14. The operator stops adjusting pressure once the indicator 38 is in the “green” or optimal zone 44

When the height needs to be raised, the operator uses the HMI to signal the ECU to operate the compressor 26 to supply air through the inlet port 20, through the module 12 to the outlet port 22. The air travels through the conduit 22 to the air springs 30 and 32. When the height is to be lowered, the HMI signals the ECU to operate the normally closed solenoid valve 16 to open and exhaust air through the exhaust 24.

The sensor 18 measures the pressure and communicates the measured pressure to the ECU 14 where it can be stored in memory. The ECU 14 then operates the compressor 26 or the solenoid valve 16 to maintain pressure over time, as the vehicle is driven. The ECU 14 employs an algorithm to maintain pressure. The ECU 14 can also monitor system pressure and filter the signals to establish trends, then inflate by energizing the compressor 26 if the pressure trend reduces (due to drop in temperature or leak for example) or deflates through the exhaust 24 if pressure increases (due to increasing temperature for example).

The ECU 14 can also alert an operator of an excessive leak, through a wired or wireless alert to a vehicle mounted light or mobile app for example.

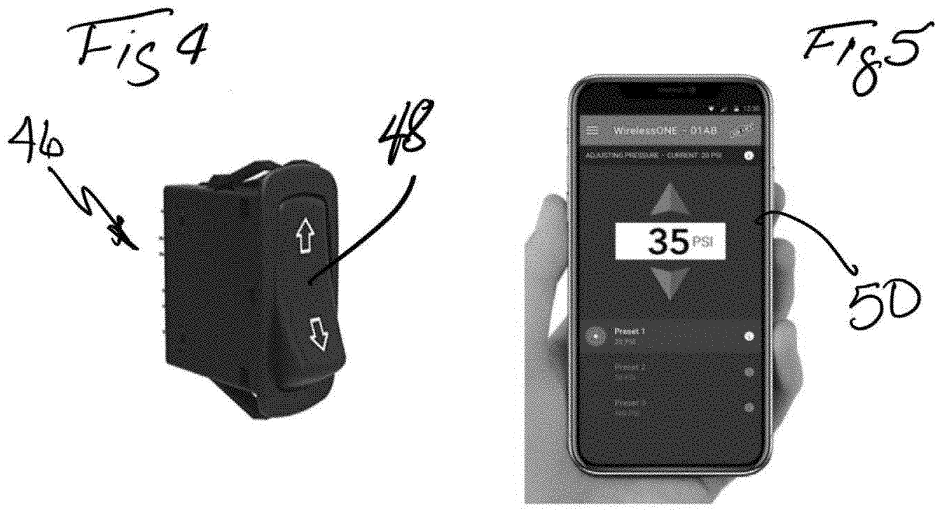

There are many options for the HMI that would work for communicating with the ECU. One example is a simple switch using a three position toggle 48. See FIG. 4. The three position toggle 48 triggers a compressor 26 ON when up, holds pressure in the middle position, and triggers exhaust through exhaust 24 when down. When the switch 48 is in the middle position, the maintain pressure algorithm will run.

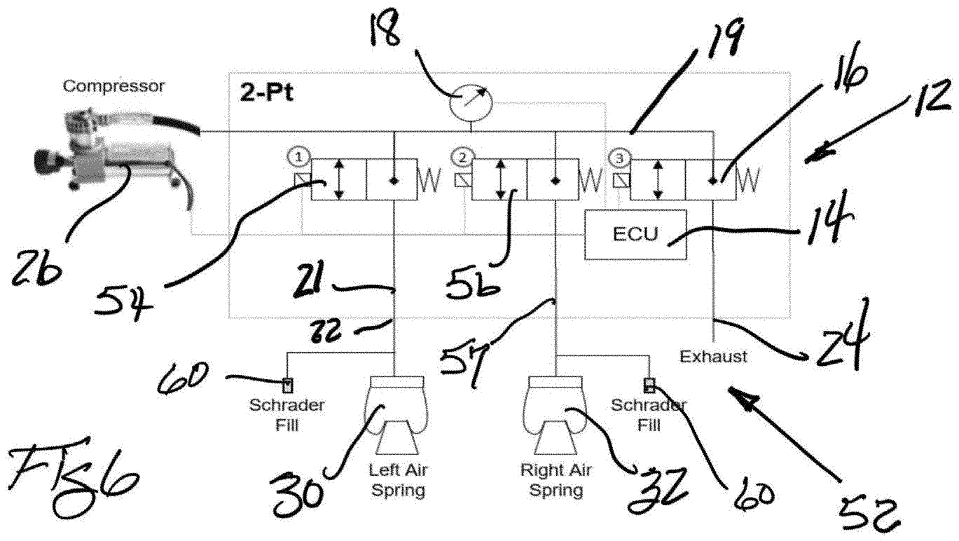

With reference to FIG. 5, another option for the HMI is a wireless Bluetooth or WiFi communication device 50. The pressure can be adjusted up and down from an app communicating with the ECU 14 and send measured pressures from the ECU 14 to the App. The App would also allow the creation and storing of presets, with touch to achieve the preset.

By adding a visible height indicator 38 and guide 40 to the air suspension 41, an operator can adjust air pressure through any type of Human-Machine Interface HMI (e.g. switch, touch panel, mobile App) to achieve a target height window 44. Once the operator achieves the target and stops actuating the HMI, the ECU 14 automatically takes over and maintains, allowing the vehicle to be operated safely.

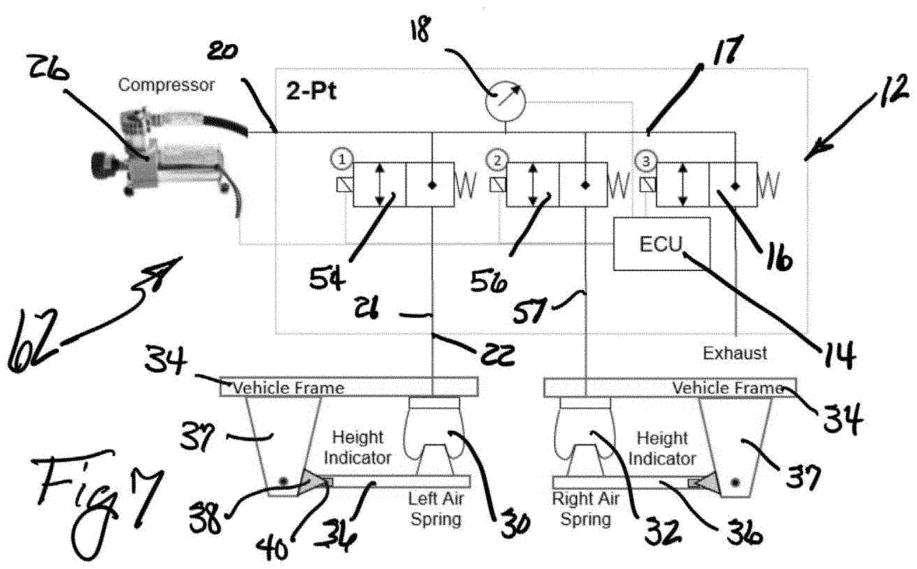

With reference to FIG. 6 a second configuration of the height adjustment system of the present invention is illustrated generally at 52. System 52 is a 2-point system. As with the previous embodiment, it uses a visible height indicator 38 and guide 40 to enable an operator to level their vehicle side-to-side using a 2-point control system and as before the system memorizes and maintains the vehicle air suspension for optimal safe driving. In this view, the indicator and gauge are not shown.

A 2-point system requires left-right isolation, where the air spring pressure cannot “cross-talk” or communicate side-to-side during normal operation including vehicle dynamic events. 2-Point systems are usually required for vehicles with high center of gravity, where if a 1-Point system was used there would be excessive vehicle body roll angle in a turn or evasive maneuver resulting in an unsafe condition.

By using three solenoids in a module it is possible to get independent control of left 30 and right 32 air springs. In this embodiment, two additional solenoids 54 and 56 are added for independent control of the left 30 and right 32 air springs. A second conduit 57 is used to communicate air from the second solenoid 56 to the air spring 32.

The ECU 14 commands the compressor 26 to ON and opens the air spring solenoid valves 54 and 56 to fill and inflate the springs 30 and 32. The valves 54 and 56 are normally closed. To exhaust, the ECU 14 commands the exhaust solenoid valve 14 and air springs solenoid valves 54 and 56 to open. To fill or exhaust one side, only the respective valve 54 or 56 is opened to inflate or opened in combination with opening valve 16 to deflate. Each side air conduit 21 and 57 could have an emergency Schrader valves 60 to allow external air fill and exhaust.

With reference to FIG. 7 a further embodiment 62 includes a visible indicator 38 and guide 40 on both sides of the vehicle. In this embodiment, an operator can separately inflate or deflate each side air suspension system to optimal suspension ride height. The ECU 14 can then memorize both left and right side pressures and automatically control, again ensuring that the vehicle is operating at its optimal ride height. This may be important for example when the vehicle is loaded with more weight on one side than the other. On nearly all towable RVs, the left or road side of the vehicle is heavier due to the kitchen and bathrooms being located on this side. The right or door side is lighter as it only has a hallway for operators to walk through. Therefore, the left side air springs 30 are nearly always required to run at a higher pressure.

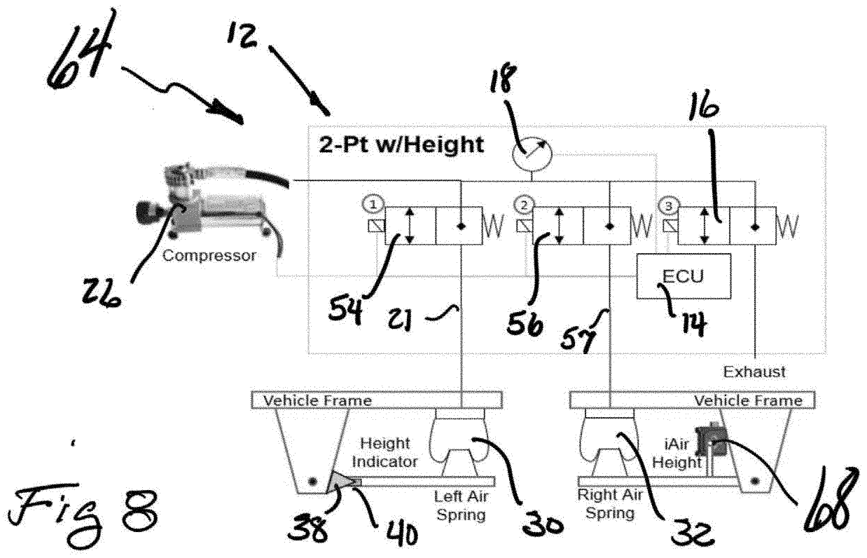

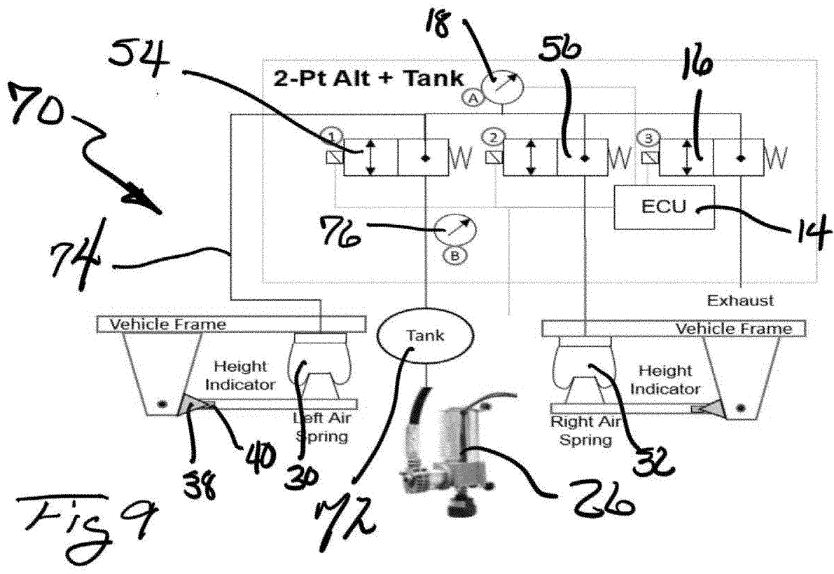

With reference to FIG. 8, a further embodiment 64 is illustrated having a height sensor 68. The height sensor 68 can be added to the module 12 to enable height control on one side, and a visible indicator 38 and guide 40 on the other side. The height sensor 68 is a non-contact height sensor integrated into the module 12 and communicating with the ECU 14. A commercially available sensor 68 is incorporated into the assignee's iAir module. The module 12 can be located on one side of the suspension 41 to sense the height of that side of the vehicle. It should be appreciated that the figures show a schematic representation of the system in all views. The module 12 in this drawing would house the ECU 14, valves 54, 56, and 16, the pressure sensor 18 and the height sensor 68. The module 12 would be mounted on one side of the vehicle. A visible height indicator 38 and guide 40 are provided on the other side to enable the operator to level that side of the vehicle independently of the other side. The ability to independently level the opposite sides is important if the loads on each side are not balanced. The ECU 14 then memorizes the separate pressure and manages the first side height and second side pressure through the height adjustment system 64.

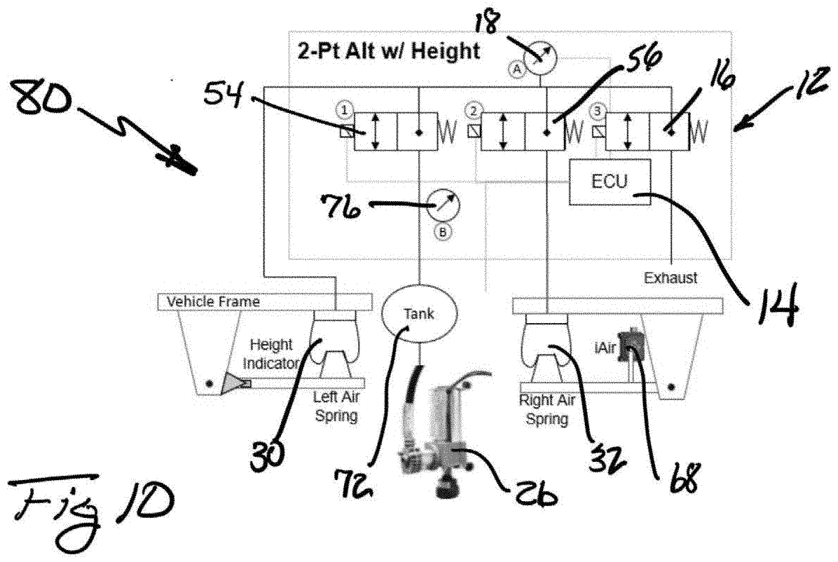

With reference to FIG. 9, a further embodiment of the height adjustment system 70 is illustrated. This embodiment adds an air tank 72 and is configured to work particularly well with vehicles that have unbalanced loads. For example as previously discussed, on nearly all towable RVs, the left or road side of the vehicle is heavier due to kitchen and bathrooms being located on this side. The right or door side is lighter as it only has a hallway for operators to walk through. Therefore, the left side air springs 30 are nearly always required to run at a higher pressure. It is possible to reconfigure module 12 to change the pneumatic plumbing and change the algorithm to add air tank 72. The air tank 72 provides immediate air pressure to the system making it more responsive to changes in the springs 30 and 32 and provides a source of air for inflating auxiliary items such as tires, floats, etc.

As illustrated in embodiment 70, the left air spring 30 is directly connected to galley through conduit or line 74. The air supplied to air spring 30 is controlled by solenoid valve 54. The tank 72 and compressor 26 feed through solenoid valve 54 and the pressure is monitored through pressure sensor 76. The pressure sensor 76 reads compressor and tank pressure continuously.

In operation, the right side 32 can be adjusted by bringing the height indicator 38 into the green zone or target height window 44. The HMI signals the ECU 14 to open valve 56 to inflate spring 32. Air is supplied by compressor 26 and tank 72 through the now open valve 54 which was opened by ECU 14. As can be seen, the left side 30 will also receive air from the galley connection. In the event the spring 32 is too high, valve 16 is opened by the ECU 14 to exhaust air pressure until the desired height is achieved. Once the height of side 32 is achieved, the HMI signals ECU 14 to store that value and maintain that pressure for side 32. Next, the side 30 is adjusted by opening valve 54 to raise and valve 16 to lower. Once side 30 is at the desired height, the ECU 14 stores that side and maintains that height.

With reference to FIG. 10, a further embodiment is shown at 80. In embodiment 80, a 2-point system, tank 72 and height sensor 68 are combined to deliver an optimized high value, low cost control system particularly adapted for use with a high center of gravity vehicle. With this solution, a single module 12 can be used that houses 3 solenoid valves 54, 56, and 16, 2 pressure sensors 18 and 76, height sensor 68 and an ECU 14 to control vehicle height and provide tank 72 for filling offboard tires, toys etc. The height sensor 68 allows the system to maintain height on side 32. Using the visible indicator 38 and guide 40, the operator can adjust the heavier side 30 to optimal ride height. Once adjustment is complete, the ECU 14 memorizes the “offset” from the height controlled side 32, and converts it into a ratio that is used to control any loading scenario.

In operation, ECU 14 memorizes left 30 and right 32 air spring pressure offset ratio. The ECU 14 maintains height on one side and pressure offset on the other side for present load in the vehicle. In the event the operator changes the vehicle load for example it is reduced, the ECU 14 controls vehicle side height. The ECU 14 sees that new pressure as read by sensor 18 to achieve target height is reduced, and applies the offset ratio to recalculate target pressure for the other side. ECU 14 commands valves 54 or 56 to fill and inflate the corresponding air spring 30 or 32 to achieve the new target pressure

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. An air suspension control system comprising:
an electronic control unit with a microprocessor;
at least one air pressure sensor operatively connected to said electronic control unit;
said at least one air pressure sensor being adapted to read air spring pressure of an air suspension;
at least one solenoid valve operatively connected to said electronic control unit, said at least one solenoid valve being adapted to exhaust air from an air suspension;
a visible height indicator adapted to visually display an air suspension height, said visible height indicator indicating an optimal range;
an air supply adapted to be operatively coupled to said electronic control unit, said air supply adapted to supply air to the air suspension;
a controller operated by an operator and operatively coupled to said electronic control unit, said controller instructing said electronic control unit to supply air from the air supply to raise the air suspension or operate said solenoid valve to exhaust air to lower the air suspension to a desired height range within said height indicator optimal range; said electronic control unit storing said desired pressure range, said electronic control unit being adapted to maintain the air suspension within said desired range.

2. The air suspension control system of claim 1, wherein said at least one solenoid valve is a normally closed 2-way valve.

3. The air suspension control system of claim 1, wherein said controller is a toggle switch.

4. The air suspension control system of claim 1, wherein said controller is a handheld device in remote communication with said ECU.

5. The air suspension control system of claim 1, wherein said at least one solenoid valve, said at least one air pressure sensor and said electronic control unit are integrated into a housing.

6. The air suspension control system of claim 1, wherein said visible height indicator is adapted to be positioned on a frame-mounted bracket and a suspension-mounted arm bracket.

7. The air suspension control system of claim 1, further including a first solenoid valve, a second solenoid valve, and a third solenoid valve for controlling first and second sides of a vehicle air suspension system, said first solenoid valve is operatively connected to said electronic control unit, said first solenoid valve being adapted to exhaust air from an air suspension; said second solenoid valve is operatively connected to said electronic control unit, said second solenoid valve is adapted to supply air or exhaust air from said first side of a vehicle air suspension system, said third solenoid valve is operatively connected to said electronic control unit, said third solenoid valve is adapted to supply air or exhaust air from said second side of a vehicle air suspension system.

8. The air suspension control system of claim 7, wherein said second and third solenoid valves are independently opened to inflate the first and second sides respectively, and said first solenoid valve is opened and said second and third solenoid valves are independently opened to deflate the first and second sides respectively.

9. The air suspension control system of claim 1, further including an electronic height sensor.

10. The air suspension control system of claim 7, further including an electronic height sensor.

11. The air suspension control system of claim 10, wherein said electronic height sensor is adapted to be mounted on said first side of said vehicle air suspension system and said visible height indicator is adapted to be mounted on said second side of said vehicle air suspension system allowing asymmetric loads to be leveled.

12. The air suspension control system of claim 1, further including an air tank for more rapid response and reservoir of air.

13. The air suspension control system of claim 1, wherein said air supply is a 12 VDC compressor.

14. An air suspension control system comprising:
an electronic control unit with a microprocessor;
a vehicle suspension with air suspension;
at least one air pressure sensor operatively connected to said electronic control unit; said at least one air pressure sensor being adapted to read air spring pressure of said air suspension;
at least one solenoid valve operatively connected to said electronic control unit, said at least one solenoid valve being adapted to exhaust air from said air suspension;
a visible height indicator adapted to visually display said air suspension height, said visible height indicator indicating an optimal range;
an air supply adapted to be operatively coupled to said electronic control unit, said air supply adapted to supply air to said air suspension;
a controller operated by an operator and operatively couple to said electronic control unit, said controller instructing said electronic control unit to supply air from the air supply to raise said air suspension or operate said solenoid valve to exhaust air to lower said air suspension to a desired height range within said height indicator optimal range; said electronic control unit storing said desired pressure range, said electronic control unit being adapted to maintain said air suspension within said desired range.

15. The air suspension control system of claim 14, wherein said at least one solenoid valve is a normally closed 2-way valve.

16. The air suspension control system of claim 14, wherein said controller is a toggle switch.

17. The air suspension control system of claim 14, wherein said controller is a handheld device in remote communication with said ECU.

18. The air suspension control system of claim 14, wherein said at least one solenoid valve, said at least one air pressure sensor and said electronic control unit are integrated into a housing.

19. The air suspension control system of claim 14, wherein said air suspension includes a bracket and suspension arm, said visible height indicator is adapted to be positioned on said frame-mounted bracket and said suspension-mounted arm.

20. The air suspension control system of claim 14, wherein said vehicle suspension has a first side air suspension and a second side air suspension;
a first solenoid valve, a second solenoid valve, and a third solenoid valve for controlling said first side air suspension and second side air suspension;
said first solenoid valve is operatively connected to said electronic control unit, said first solenoid valve being adapted to exhaust air from said first and second side air suspensions; said second solenoid valve is operatively connected to said electronic control unit, said second solenoid valve is adapted to supply air or exhaust air from said first side air suspension, said third solenoid valve is operatively connected to said electronic control unit, said third solenoid valve is adapted to supply air or exhaust air from said second side air suspension.

21. The air suspension control system of claim 20, wherein said second and third solenoid valves are independently opened to inflate the first and second side air suspension respectively, and said first solenoid valve is opened and said second and third solenoid valves are independently opened to deflate the first and second sides air suspension respectively.

22. The air suspension control system of claim 14, further including an electronic height sensor.

23. The air suspension control system of claim 20, further including an electronic height sensor.

24. The air suspension control system of claim 23, wherein said electronic height sensor is adapted to be mounted adjacent said first side air suspension and said visible height indicator is adapted to be mounted said second side air suspension allowing asymmetric loads to be leveled.

25. The air suspension height control system of claim 14, further including an air tank for more rapid response and reservoir of air.

26. The air suspension control system of claim 14, wherein said air supply is a 12 VDC compressor.
